(19) United States
(12) Patent Application Publication
(10) Pub. No.: US 2005/0105174 A1
(43) Pub. Date: May 19, 2005

(54) Microscope system

(75) Inventors: Yasushi Ogihara, Kanagawa-ken (JP); Ryosuke Komatsu, Yamato-Shi (JP)

Correspondence Address: MORGAN LEWIS & BOCKIUS LLP, 1111 PENNSYLVANIA AVENUE NW, WASHINGTON, DC, 20004, US

(73) Assignee: Nikon Corporation

(21) Appl. No.: 10/954,474

(22) Filed: Oct. 1, 2004

(30) Foreign Application Priority Data
Oct. 3, 2003 (JP) 2003-346203

(51) Int. Cl. G03B 7/099

(52) U.S. Cl. 359/383; 359/368

(57) ABSTRACT

A microscope system includes a plurality of objectives with different magnifications and a focus adjustment device that adjusts a focus position of the objective. The focus adjustment device starts executing the focus adjustment operation as the user operates the AF button. Even when no instruction to start the focus adjustment operation according to operation of the AF button is issued, the focus adjustment operation can be started when the user operates the objective selection switch to switch over from the low magnification objective to the high magnification objective.

### INCORPORATION BY REFERENCE

The disclosure of the following priority application is herein incorporated by reference:
Japanese Patent Application No. 2003-346203 filed Oct. 3, 2003

### BACKGROUND OF THE INVENTION

1. Field of the Invention

The present invention relates to a microscope system equipped with a focusing device.

2. Description of Related Art

A microscope system disclosed in Japanese Laid-Open Patent Publication No. 2001-21793 comprises an optical microscope having a motorized nosepiece device and a focusing unit (AF unit) that is an automatic focus device mounted at the optical microscope. The AF unit comprises an AF optical system, an AF control unit that carries out autofocus control, an electric motor for autofocus, and a hand switch operated to set presence/absence of an objective at each hole in the motorized nosepiece, to select ON/OFF of autofocus control and to switch-over the objectives. The AF control is started or ended by pressing an AF button installed in the hand switch. When a user presses the AF button after shift ng an observation position (an observation point) of a specimen, the objective can be focused on the observation point of the specimen.

However, in the above-described microscope system of the related art, it is necessary for a user to instruct to start the focusing operation in order to engage the focusing device in operation again after the magnification of the objective is changed or after the observation point is changed during observation of the specimen, causing the user a great deal of trouble.

### SUMMARY OF THE INVENTION

A microscope system according to a first aspect of the present invention comprises an objective optical system that uses an objective among a plurality of objectives with different magnifications to observe a specimen; a focus adjustment device that adjusts a focus position of the objective optical system; a start instruction device that instructs to start operation of the focus adjustment device; an objective selection device that selects the objective among the plurality of objectives; a switching instruction device that instructs the objective selection device to change the objective; and a control device that controls the operation of the focus adjustment device in accordance with an instruction to change the objective issued from the switching instruction device when no instruction to start the operation of the focus adjustment device is issued from the start instruction device.

A microscope system according to a second aspect of the present invention comprises a macro image capturing device that captures a macro image of a specimen; a macro image display device that displays the macro image captured by the macro image capturing device; a specifying device that specifies an observation position of a micro image in the specimen on a display screen of the macro image displayed in the macro image display device; an observation position control device that matches the observation position of the specimen specified by the specifying device with an optical axis of an objective optical system; a micro image capturing device that captures the micro image of the specimen at the observation position specified by the specifying device via the objective optical system; a micro image display device that displays the micro image captured by the micro image capturing device; a focus adjustment device that adjusts a focus position of the objective optical system; and a control device that (a) controls the micro image capturing device to captures the micro image of the specimen, (b) controls the focus adjustment device to carry out focus adjustment operation after the captured micro image is displayed on the micro image display device, (c) controls the micro image capturing device to capture the micro image again, and (d) updates the micro image displayed on the micro image display device.

A microscope system according to a third aspect of the present invention comprises an objective optical system used to observe a specimen; a focus adjustment device that adjusts a focus position of the objective optical system; a start instruction device that instructs to start operation of the focus adjustment device; a specifying device that specifies an observation position of the specimen; an observation position control device that matches the observation position of the specimen specified by the specifying device with an optical axis of the objective optical system; and a control device that engages the focus adjustment device in operation after the observation position control device matches the observation position with the optical axis in accordance with a signal from the specifying device in a case no instruction to start the operation is issued from the start instruction device.

### BRIEF DESCRIPTION OF THE DRAWINGS

FIG. 1 shows an overall structure adopted in a microscope system in a first embodiment of the present invention.

FIG. 2 shows an example of a relationship between a Z coordinate and a contrast value.

FIG. 3 is a flow chart that shows processing procedure of AF control executed in the microscope system of the first embodiment.

FIG. 4 shows an overall structure adopted in a microscope system in the second embodiment.

FIG. 5 illustrates the depth of focus of object lens.

### DESCRIPTION OF PREFERRED EMBODIMENTS

### First Embodiment

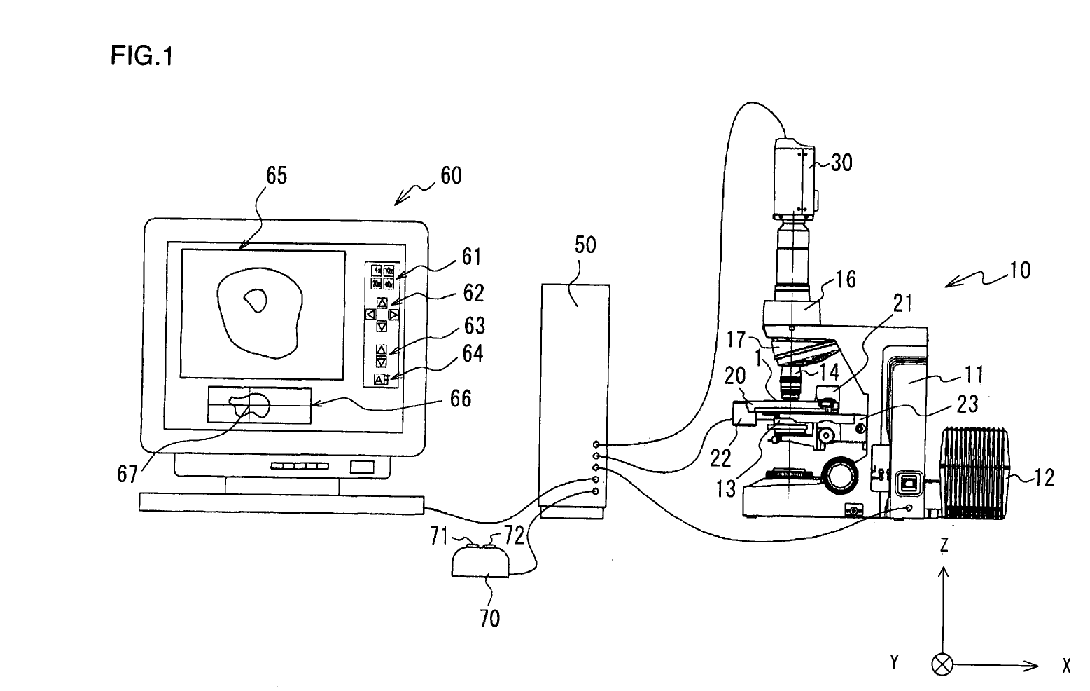

FIG. 1 shows an overall structure adopted in a microscope system in a first embodiment of the present invention. The microscope system equipped with a focus adjustment device includes a microscope 10, a display device, for instance, a video monitor that displays an observation image of a specimen obtained by the microscope 10, and a controller 50 that controls operations of the microscope 10 and the video monitor 60. The microscope 10 and the video monitor 60 are each connected with the controller 50 via signal lines.

The microscope 10 has a light source 12, a condenser lens 13, an objective optical system 14, a lens barrel 16, a motorized nosepiece 17, a motorized XY stage 20, a sub-stage 23, a CCD camera 30, etc. as shown in FIG. 1. The objective optical system 14 includes a plurality of objectives as described later. A slide glass 1 on which a specimen (not shown) is held is mounted on the motorized XY stage 20 of the microscope 10. An optical image of the specimen on the slide glass 1 is formed on a CCD imaging surface built into the CCD camera 30 via an objective 14 positioned on an observation optical axis and the lens barrel. The optical image of the specimen is then converted into image signals by the CCD, and outputted to the controller 50. The controller 50 subjects the image signals sent from the CCD camera 30 to predetermined image processing and outputs the specimen image thus obtained to the video monitor 60 as a picture. The image signals outputted from the CCD camera 30 are also used to operate the focus detection.

The focus adjustment device of the microscope system is constituted of the CCD camera 30 and the controller 50.

In the motorized XY stage 20, two stepping motors 21 and 22 are provided and the slide glass 1 can be moved in an X direction and a Y direction, i.e., directions perpendicular to the optical axis. A guide and a stepping motor (not shown) utilized to move the motorized XY stage 20 and the sub-stage 23 in an up-and-down direction, i.e., in a Z direction corresponding to the optical axis, are built into a microscope main body 11. By driving the stepping motor to move the motorized XY stage 20 and the sub-stage 23 in the up-and-down direction, the specimen held on the slide glass 1 can be brought in focus.

Four switches 62 to cause the motorized XY stage 20 to move in the X and Y directions, i.e., switches for moving the stage in both sides of the X direction and both sides of the Y direction, switches 63 to cause the motorized XY stage 20 and the sub-stage 23 to move up and down, i.e., switches for moving the stages in the Z direction are provided on the video monitor 60 in the form of GUI (Graphical User Interface). A user uses a mouse 70 connected to the controller in order to operates these switches 62 and 63. The mouse 70 includes a right button 71 and a left button 72. In the case the user manually adjusts the focus, he or she operates the up-down switches 63 by using the mouse 70 while checking the specimen image displayed on the video monitor 60 until the focus matches on the specimen image. The stage 20 and the sub-stage 23 are then stopped.

In addition, objective selection switches 61 and an auto focus (AF) button 64 are provided on the video monitor 60 in the form of GUI. The user can select an objective of the desired magnification among the plurality of objective lenses 14, each objective having different magnification (in a range between high magnification and low magnification), by operating the selection switch 61 with the mouse 70. It is to be noted that the objective optical system 14 includes an objective for the macro image and objectives for the micro image with different magnifications.

The controller 50 is constituted of CPU and CPU periphery devices such as ROM and RAM, and controls operation of the microscope 10 and display on the video monitor 60 in the form of software.

First, the controller 50 selects the objective 14 for the macro image to acquire an overall image (macro image) of the slide glass 1 holding the specimen when the specimen is put on stage 20. Then, the macro image of the specimen is captured by the CCD camera 30 via the objective 14 for the macro image. After acquiring the macro image captured by the CCD camera 30, the controller 50 controls the video monitor 60 to put up on display the macro image of the specimen.

After the macro image is acquired, an objective 14 for the magnified image (micro image) of the specimen is automatically selected. The CCD camera 30 captures the micro image of the specimen via the objective 14 for the micro image. The controller 50 acquires the micro image thus captured and displays the micro image of the specimen on a micro image zone 65 of the video monitor 60. In the macro image zone 66, a cross mark 67 is displayed on the macro image at a position corresponding to the micro image. That is, apart of the specimen centered around the point that the cross mark 67 specifies is displayed in the micro image zone 65 as the micro image of the specimen.

This cross mark 67 can be moved by operating the switches 62. That is, the position of cross mark 67 changes when the motorized XY stage 20 moves in the X and Y directions in response to the operation of the switches 62 so as to change the observation position of the specimen. Moreover, the positional relationship between the macro image zone 66 and micro image zone 65 of the video monitor 60, and the stage 20 is defined and stored in memory in the controller 50. Therefore, it is also possible that the stage 20 is moved in the X and Y directions to locate the cross mark 67 at a specified position when a desired point in the macro image zone 66 on the video monitor 60 is specified by using the mouse 70.

After the macro image of the specimen is captured, the objective 14 for the micro image with a high magnification is automatically selected as the objective, that is, the objective 14 for the micro image is positioned in the observation optical axis, in order to capture the micro image. If a user wishes to change the magnification of the objective 14 for the micro image while observing the specimen, the user operates the objective selection switch 61 displayed on the video monitor 60 by using the mouse 70.

The controller 50 controls the motorized nosepiece 17 in response to the operation of the objective selection switch 61. The motorized nosepiece 17 includes a motor (not shown) therein and switches over the objectives with different magnifications attached at holes in the nosepiece in accordance with an instruction signal for switching-over inputted from the controller 50. As a result, the objective 14 of the selected magnification according to the operation of the objective selection switch 61 is inserted into the observation optical axis (optical path).

In a parfocal data memory unit in the controller 50, sets of data indicating a deviation (difference) between a focus position of an objective 14 and a focal position of an adjacent objective 14, hereinafter referred to as parfocal data, are stored. When the objectives are changed over by the motorized nosepiece 17, the stage 20 and the sub-stage 23 are moved in the Z direction so as to match the specimen to the focus position of a newly selected objective 14 based upon the difference (parfocal data) between the focus position of the objective 14 previously inserted in the observation optical axis and the focus position of the objective 14 newly positioned in the observation optical axis. In this embodiment, operation to adjust a position of the specimen in the direction of the optical axis based upon the parfocal data upon changing-over of the objectives as described above is referred to as parfocal data correction operation.

A focus adjustment unit in the controller 50 carries out auto focus operation in a so-called image contrast method by using the image signals obtained from the CCD camera 30. The following is an explanation to the autofocus (AF) operation. The user operates the AF button 64 on the video monitor 60 by using the mouse 70. The controller 50 starts a series of operations to complete the AF operation in response to an AF startup instruction by the user.

A program for focus adjustment stored in the focus adjustment unit starts running when the AF button 64 on the video monitor 60 is operated. The controller 50 drives the stepping motor of the microscope 10 to move the stage 20 and the sub-stage 23 within a predetermined search range in a vertical direction. i.e., in the Z direction. Here, the search range is a range within which the stage 20 and the sub-stage 23 are caused to move in the vertical direction to detect a contrast of the captured image.

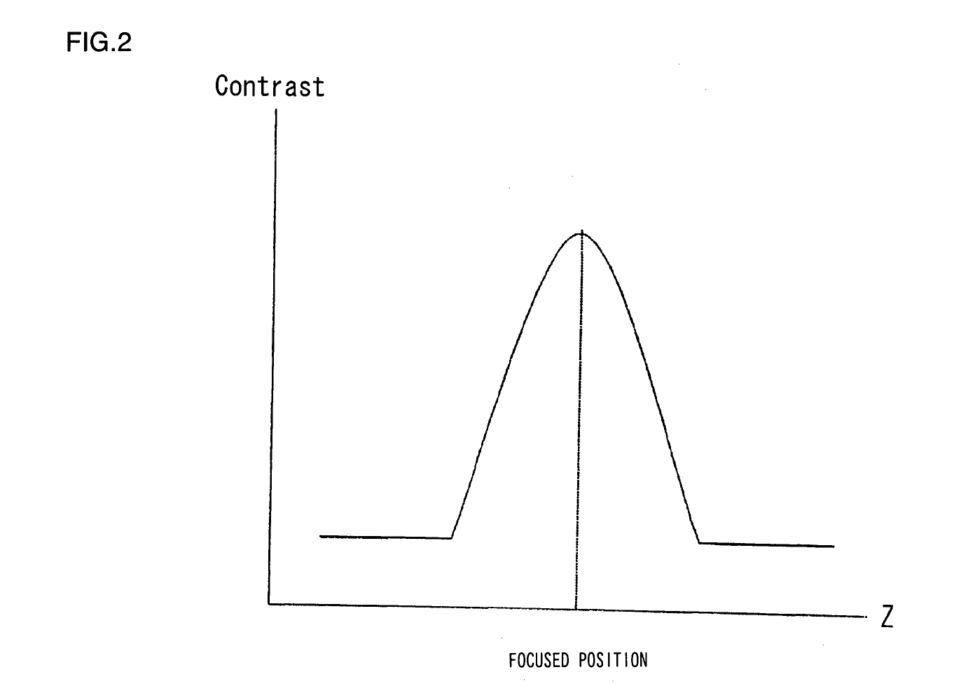

The controller 50 detects the contrast of the image signal (digital image information) input from the CCD camera 30 at a predetermined sampling interval while moving the stage 20 and the sub-stage 23 within the search range. The controller 50 then profiles the relationship between the detected contrast value and the Z coordinate of the stage 20. FIG. 2 shows an example of the relationship between the contrast value and the Z coordinate with the vertical axis representing the contrast value and the horizontal axis representing the Z coordinate of the stage 20. In a profile having a peak as shown in FIG. 2, the Z coordinate of the maximum value of the contrast (peak value) corresponds to a focus position of the objective 14 (a focused position). After the stage 20, that is, the specimen is moved to the focused position thus obtained, the focusing operation is completed.

In the first embodiment, the AF operation can also be started in accordance with either switching-over of the objectives 14 or movement of the stage 20 in addition to the operation of the AF button 64 by the user as explained above.

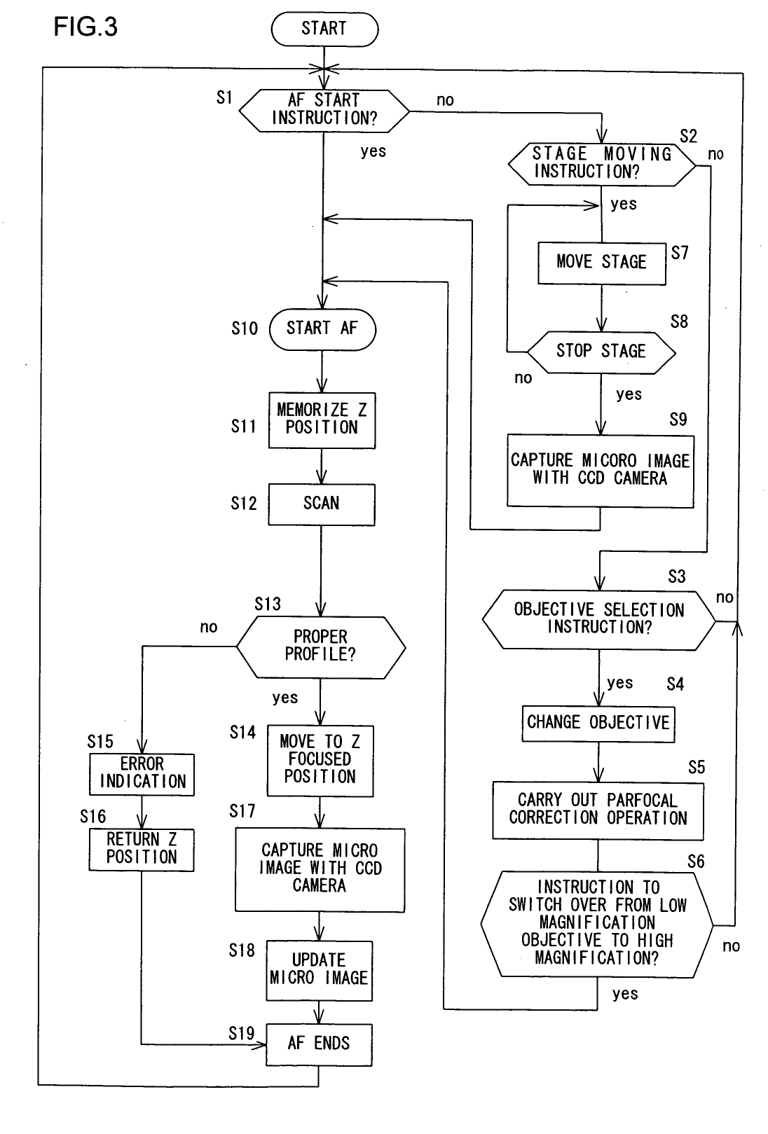

The operations of the microscope system according to the first embodiment is now described in detail with reference to FIG. 3. FIG. 3 is a flow chart that shows processing procedure of the focus adjustment control and the micro image capturing control executed by the controller 50 of the first embodiment.

(Explanation of AF Operation Start Sequence Upon Changing-Over of Objectives)

The focus adjustment unit in the controller 50 starts the AF operation when the user operates the objective selection switch 61 to instruct to switch over an objective 14 of a low magnification to an objective 14 of a high magnification. First, this operation will be explained with reference to FIG. 3.

In step S1, it is determined as to whether or not the AF button 64 is turned on and the AF start signal is output. If the AF start signal is not output, step S2 is proceeded to. In step S2, it is determined as to whether or not an instruction to move the stage 20 according to the operation of the switch 62 is output. If the instruction to move the stage 20 is not output, step S3 is proceeded to.

In step S3, it is determined as to whether or not the objective selection switch 61 is operated by the user to instruct switching-over of the objectives. If an instruction to switch-over the objective 14 is issued, step S4 is proceeded to, whereas the processing returns to step S1 if no instruction to switch-over is issued.

In step S4, the motorized nosepiece 17 is driven and an objective 14 of a high magnification selected by the objective selection switch 61 is positioned on the observation optical axis. Next, in step S5, the parfocal data correction operation is carried out based on the parfocal data between the objective 14 newly arranged on the observation optical axis and the objective 14 previously inserted in the observation optical axis as described above.

In step S6, it is determined as to whether or not the instruction issued by operation of the objective selection switch 61 is to change the magnification of the objective 14 from a low magnification to a high magnification. Step S10 is proceeded to if it is instructed to change the magnification of the objective 14 from a low magnification to a high magnification, whereas processing is returned to step S1 if it is instructed to change the magnification from a high magnification to a low magnification.

In step S10, the AF processing begins. Details of the AF processing are described later.

As described above, when the objective 14 for micro image of a low magnification is changed over to the objective 14 for micro image of a high magnification, the parfocal data correction operation is carried out and the AF operation is also carried out. On the other hand, when the objective 14 for micro image of a high magnification is changed over to the objective 14 for micro image of a low magnification, only the parfocal data correction is carried out but the AF operation is not carried out. This is because the specimen image easily goes out of focus when changing over from the objective 14 for micro image of a low magnification to the objective 14 for micro image of a high magnification, whereas the specimen image usually remains in focus when changing over from a high magnification to a low magnification.

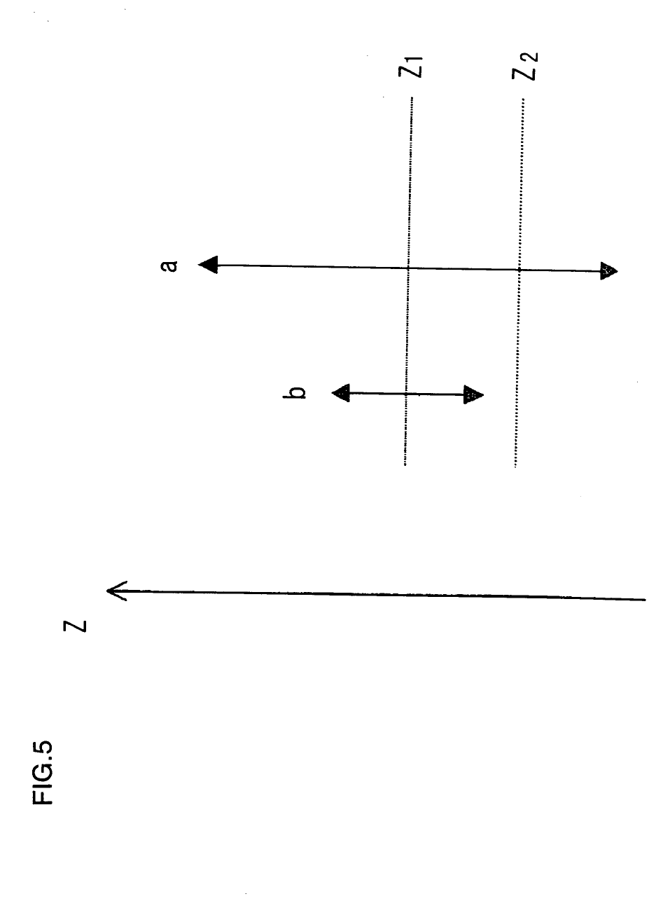

FIG. 5 schematically illustrates the depth of focus of objectives with different magnifications. In FIG. 5, the vertical axis represents the Z coordinate. The depth of focus “a” of an objective with a low magnification is greater than the depth of focus “b” of an objective with a high magnification as shown in FIG. 5. Thus, in the case the Z coordinate of the specimen, i.e., the Z coordinate of the stage 20, is at a position Z1 when the specimen is observed by using the objective of a low magnification, the position Z1 of the stage 20 will be within the depth of focus “b” even when changing over to the objective of a high magnification. That is, the specimen can be observed in a focused state after changing over to the objective of a high magnification. However, in the case the stage 20 is at a position Z2 during observation using the objective of a low magnification, the position Z2 will be deviated from the depth of focus “b” when switching to the objective of a high magnification, which makes the specimen image go out of focus.

The Z coordinate of the stage 20 is positioned within the depth of focus “b” during observation using the objective of a high magnification, and thus, the Z coordinate of the stage 20 stays within the depth of focus “a” even when switching to the objective of a low magnification. Therefore, there is no need of carrying out the AF operation because the focused state is ensured when changing over from a high magnification to a low magnification. On the other hand, the AF operation is to be implemented when changing over from a low magnification to a high magnification.

(Explanation of AF Operation Start Sequence by Shifting Observation Point (Moving Stage))

Next, the explanation is given how to start the AF operation in response to the movement of stage 20. The user selects a desired observation point in the specimen by using the cross mark 67 on the macro image zone 66 of the video monitor 60. The controller 50 electrically drives the stage 20 to move the selected observation point to the observation optical axis in order to acquire a micro image of the selected observation point. And then, the AF operation starts.

In step S1, a negative determination is made since the AF start signal is not outputted from the AF button, and processing proceeds to step S2. In step S2, the controller 50 reads the coordinates of the cross mark 67 in the macro image zone 66 (XY coordinates), and outputs an instruction to move the stage 20 to the stepping motor 22. In step S7, the stepping motor 22 moves the stage 20 in the X direction and Y direction in conformance to the movement instruction from the controller 50.

In step S8, when it is detected that the stage 20 has reached a position corresponding to an observation point specified by the cross mark 67, that is, the observation point of the specimen matches to the observation optical axis, the stage 20 is stopped. For instance, the extent of movement of the stage 20 can be monitored by using detection values of encoders installed in the stage 20 to detect the X coordinate and the Y coordinate. After it is detected that the stage 20 is stopped, the micro image of the observation point of the specimen is captured by the CCD camera 30 in step S9. And then, processing advances to step S10 to start the AF processing.

When the stage 20 is moved and the observation point is shifted as described above, the micro image of the specimen is captured by the CCD camera 30, and the captured micro image is displayed in the micro image zone 65 temporarily. The micro image of the specimen is again captured after the AF operation so that the micro image displayed in the micro image zone 65 is updated.

(Explanation of Focus Adjustment Sequence and Update of Micro Image)

Next, the focus adjustment process and the micro image update process after the AF processing starts in step S10 will be explained.

After the AF process starts up in step S10, processing proceeds to step S11 to store in memory the Z coordinate of the stage 20 at that time point. In step S12, the stage 20 is moved to a Z coordinate corresponding to a search starting position set in advance, and the search for the contrast (scanning) within a predetermined range begins. At the same time, the focus adjustment unit in the controller 50 calculates the contrast value of the captured image with respect to a Z coordinate based on the image information inputted from the CCD camera 30 while moving the stage 20 in the Z direction within the search range. And, a profile is generated with the contrast value manifesting along the vertical axis and the Z coordinate of the stage 20 manifesting along the horizontal axis.

In step S13, it is determined as to whether or not the profile generated in the focus adjustment unit in step S12 is proper. In this embodiment, presence/absence of a peak of the contrast value within the search range is detected so as to determine whether or not a profile is proper. If the peak of the contrast value is included, it is determined that the generated profile is proper and processing proceeds to step S14.

In step S14, the Z coordinate of the peak of the contrast value, that is, a focused position is calculated based on the generated profile. The AF operation is completed after moving the stage to the focused position. In step S17, the micro image of the specimen in a focused state is captured by the CCD camera 30. In step S18, the micro image of the specimen thus captured is displayed in the micro image zone 65. At this time, the position in the specimen displayed as the micro image is indicated by the cross mark 67 on the macro image zone 66.

On the other hand, step S15 is proceeded to when it is determined that a proper profile was not obtained in step S13. In step S15, error indication is put up on display of the video monitor 60 that indicates a proper profile was not obtained. And then, in step S16 the stage 20 is moved to an initial position memorized in step S11. A series of AF operation terminates in step S19.

As described above, the microscope system includes the objective optical system 14 that uses an objective among a plurality of objectives with different magnifications to observe a specimen, the focus adjustment device that adjusts a focus position of the objective optical system 14, the AF button (a start instruction device) 64 that instructs to start operation of the focus adjustment device, the motorized nosepiece (an objective selection device) that switches over between the plurality of objectives 14, the objective selection switch (a switching instruction device) 61 that instructs the motorized nosepiece to change the objective 14, and the controller 50. The controller 50 controls the operation of the focus adjustment device in accordance with an instruction to change the objective 14 issued from the objective selection switch 61 when no instruction to start the focus adjustment operation is issued from the AF button 64. In this manner, the focus adjustment can be carried out even when the user does not operates the AF button 64 to instruct to start the focus adjustment control.

The controller 50 starts executing the focus adjustment control as the objective selection switch 61 outputs a signal to instruct to switch-over from the objective 14 with a low magnification to the objective 14 with a high magnification. The specimen image may go out of focus when the objective of a low magnification is switched over to the objective of a high magnification since the depth of focus “b” for the objective with a high magnification is smaller than the depth of focus “a” of the objective with a low magnification as shown in FIG. 5. By automatically beginning the focus adjustment control, it is possible to reliably focus on the specimen being observed without the user operating the AF button 64.

On the other hand, when the instruction is issued from the objective selection switch 61 to switch over from the objective 14 with a high magnification to the objective 14 with a low magnification, the controller 50 does not execute the focus adjustment control. The specimen image remains in focus even when the objective with a high magnification is switched over to the objective with a low magnification because the depth of focus “a” of the low magnification objective is greater than the depth of focus “b” of the high magnification objective as shown in FIG. 5. Therefore, the specimen can be observed in a focused state without executing the focus adjustment control.

As described above, the microscope system further includes the parfocal data storage unit (a parfocal data storage device) that stores in memory parfocal data that indicate a difference in focus positions between the plurality of objectives, and the parfocal correction device that adjusts the focus position of the objective optical system 14 based on the parfocal data in accordance with the instruction to change the objective 14 issued from the objective selection switch. The controller 50 carries out the parfocal data correction operation and starts implementing the focus adjustment control in response to a signal from the objective selection switch 61 to switch over from the objective 14 of a low magnification to the objective 14 of a high magnification. By doing this, the parfocal data correction and the focus adjustment control are carried out when the low magnification objective 14 is switched to the high magnification objective, and thus it is possible to promptly focus on the specimen which is being observed.

On the other hand, the controller 50 carries out the parfocal data correction operation but does not execute the focus adjustment control when a signal is outputted from the objective selection switch 61 to switch over from the objective 14 of a high magnification to the objective 14 of a low magnification. The specimen image stays in focus when the high magnification objective is switched over to the low magnification objective as mentioned above, and thus the specimen can be observed in a focused state without executing the focus adjustment control.

In the microscope system, the CCD camera 30 (a macro image capturing device and micro image capturing device) captures a macro image and micro image of the specimen mentioned above. The macro image and the micro image thus captured are displayed in the macro image zone 66 and the micro image zone 65 of the video monitor 60 respectively. When the user operates the mouse 70 (a specifying device) to specify an observation position to be observed as the micro image of the specimen on the macro image zone 66, the controller 50 controls to set the optical axis of the objective optical system 14 to the specified observation position of the specimen. The controller 50 controls the CCD camera 30 to capture the micro image of the specimen according to the operation of the mouse 70, and has the captured micro image displayed in the micro image zone 65. The focus adjustment control is then carried out and the micro image of the specimen is again captured with the CCD camera 30 so that the micro image in the micro image zone 65 is updated with the micro image which is newly captured. Accordingly, by specifying a desired observation point with the mouse 70, the user can observe the specimen in a focused state without bothering to operate the AF button 64.

The controller 50 drives the stepping motors 21 and 22 (an observation position control device) to move the stage 20 in the XY plane perpendicular to the optical axis of the objective optical system 14 so as to move the observation point of the specimen specified by the cross mark 67 to the optical axis of the objective optical system 14. When it is detected that the observation position of the specimen has reached the optical axis, the controller 50 begins executing the focus adjustment control. By doing this, it is possible to reliably focus on the specimen at the observation point that the user desires.

In the microscope system, the focus adjustment control can also be started with the controller 50 after matching the observation position of the specimen with the optical axis of the objective optical system 14 according to the operation of the mouse 70 while no instruction to start the focus adjustment control is issued from the AF button 64. By doing this, even when the user does not operate the AF button 64 to instruct to start the focus adjustment operation, it is possible to focus on the observation position of the specimen desired by the user.

When the observation position in the specimen is changed according to the operation of the mouse 70 after the image of the specimen captured with the CCD camera 30 is displayed on the video monitor 60, the controller 50 begins the focus adjustment control. The specimen image is captured again with the CCD camera 30 after the focus adjustment control is completed, and the image displayed in the video monitor 60 is updated. As a result, the user can observe the specimen with a desired observation position being in focus without operating the AF button 64.

The focal point detection can be reliably carried out since a focal position of the objective optical system 14 is detected with the controller 50 based on the image of the specimen captured with the CCD camera 30.

### Second Embodiment

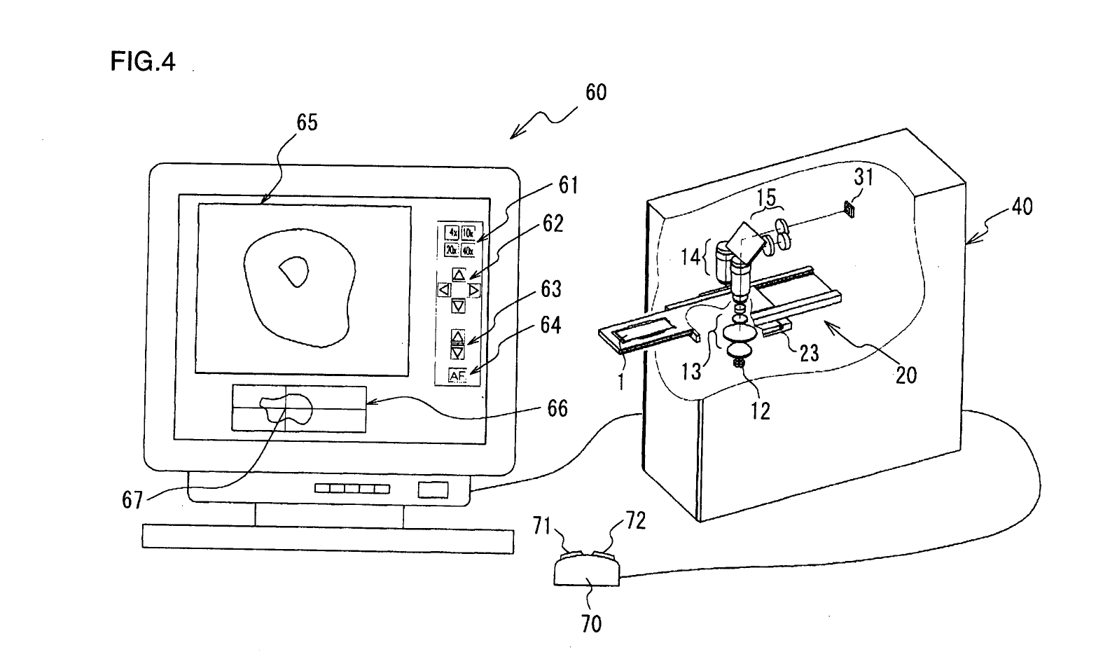

A microscope system according to the second embodiment will be described. FIG. 4 shows an overall structure adopted in the microscope system in the second embodiment. In the microscope system shown in FIG. 4, the same reference numerals are given to members identical to those of the first embodiment shown in FIG. 1. Here, explanation mainly focuses on the difference from the first embodiment.

In the microscope system according to the second embodiment, alight source 12, a condenser lens 13, an objective optical system 14, a second objective 15, a motorized XY stage 20, a sub-stage 23, an image-capturing element 31, a controller (not shown), etc., as a whole are housed in a housing 40 as shown in FIG. 4. The Image-capturing element 31 functions in the same manner as the CCD camera 30 in the first embodiment. In the second embodiment, the microscope 10 and the controller 50 of the first embodiment are built into the housing 40, but the basic operation of the microscope and controller is similar to that of the first embodiment as described above.

The micro image of the specimen obtained using the objective 14 for micro image is displayed in the micro image zone 65 on the video monitor 60 in real time in the same manner as the first embodiment. The macro image including substantially whole area of the slide glass 1 on which the specimen is placed is displayed in the macro image zone 66.

The macro image of the specimen is obtained in the same manner as the first embodiment described above when the specimen put on the stage 20 is inserted into the housing 40 and is moved to the observation optical axis. It is to be noted that the macro image is generated as an overall image by capturing images of a plurality of regions in the specimen using an objective 14 of a low magnification and the second objective 15 and joining together the plurality of captured images.

Setting of the observation position of the micro image in the specimen, starting of the AF operation and the operation of AF process are carried out in the same manner as the first embodiment described above. In this manner, even when the microscope system is constructed as shown in FIG. 4, the effect similar to that of the first embodiment described above can be achieved.

In the first and second embodiments, the micro image of the specimen is automatically captured after the macro image is captured and then both of the macro image and micro image are displayed on the video monitor 60. However, the present invention is by no means limited, and it is also possible to capture only a micro image of the specimen for instance. Even in this case, the focus adjustment control is started when the magnification of the objective 14 is changed in response to operation of the objective selection switch 61 or when the observation position in the specimen is shifted by operation of the mouse 70. As a result, the user can observe the specimen in a focused state without operating the AF button 64.

The user clicked the buttons 71 and 72 of the mouse 70 to issue various instructions or selection in the first and second embodiments mentioned above. In general, a mouse 70 in market has two buttons 71 and 72 in right and left. Thus, it is possible for the AF process to start running only when the user clicks the right button 72 of the mouse 70 in the case the stage is moved or the objectives are changed over to start the AF process.

In the first and second embodiments, explanation was given to examples where the cross mark 67 on the macro image zone 66 was shifted to a desired observation point in accordance with the operation of the switches 62 and where a desired observation point was specified by using a cursor which is moved in correspondence with the operation of the mouse 70. However, a moving means for moving the stage 20 is by no means limited to these examples. For instance, an operation pad at which a joystick and a trackball are installed may be used. As an alternative, it is possible to use a video monitor in which a display screen for putting up on display an image is a touch panel so that various operational instructions are issued as the user touches the display screen directly.

While the stage 20 is moved along the Z direction to detect the focused position of the specimen in the first and second embodiments described above, an optical system including the objective 14 can be moved along the optical axis with the stage being fixed. Moreover, it is also possible to move the optical system including the objective 14 in a direction substantially perpendicular to the optical axis so as to change the observation position of the specimen instead of moving the stage 20 in the XY plane.

While an explanation was given to an example of a microscope system having the microscope as shown in FIGS. 1 and 5 in the above described first and second embodiments, the present invention can be applied to a microscope in another form.

The above-described embodiments are examples, and various modifications can be made without departing from the spirit and scope of the invention.

1. A microscope system, comprising:
an objective optical system that uses an objective among a plurality of objectives with different magnifications to observe a specimen;
a focus adjustment device that adjusts a focus position of the objective optical system;
a start instruction device that instructs to start operation of the focus adjustment device;
an objective selection device that selects the objective among the plurality of objectives;
a switching instruction device that instructs the objective selection device to change the objective; and
a control device that controls the operation of the focus adjustment device in accordance with an instruction to change the objective issued from the switching instruction device when no instruction to start the operation of the focus adjustment device is issued from the start instruction device.

2. A microscope system according to claim 1, wherein:
the control device engages the focus adjustment device in operation when the switching instruction device instructs to change from an objective with a low magnification to an objective with a high magnification.

3. A microscope system according to claim 1, wherein:
the control device does not engage the focus adjustment device in operation when the switching instruction device instructs to change from an objective with a high magnification to an objective with a low magnification.

4. A microscope system according to claim 1, further comprising:
a parfocal data storage device that stores in memory parfocal data that indicate a difference in focus positions between the plurality of objectives; and
a parfocal correction device that adjusts the focus position of the objective optical system based on the parfocal data in accordance with the instruction to change the objective issued from the switching instruction device, wherein:
the control device engages the parfocal correction device and the focus adjustment device in operation when the switching instruction device instructs to change from an objective with a low magnification to an objective with a high magnification.

5. A microscope system according to claim 1, further comprising:
a parfocal data storage device that stores in memory parfocal data that indicate a difference in focus positions between the plurality of objectives; and
a parfocal correction device that adjusts the focus position of the objective optical system based on the parfocal data in accordance with the instruction to change the objective issued from the switching instruction device, wherein:
the control device (a) engages the parfocal correction device and the focus adjustment device in operation when the switching instruction device instructs to switch over from an objective with a low magnification to an objective with a high magnification, and (b) engages the parfocal correction device in operation but does not engage the focus adjustment device in operation when the switching instruction device instructs to change from an objective with a high magnification to an objective with a low magnification

6. A microscope system, comprising:
a macro image capturing device that captures a macro image of a specimen;
a macro image display device that displays the macro image captured by the macro image capturing device;
a specifying device that specifies an observation position of a micro image in the specimen on a display screen of the macro image displayed in the macro image display device;
an observation position control device that matches the observation position of the specimen specified by the specifying device with an optical axis of an objective optical system;
a micro image capturing device that captures the micro image of the specimen at the observation position specified by the specifying device via the objective optical system;
a micro image display device that displays the micro image captured by the micro image capturing device;
a focus adjustment device that adjusts a focus position of the objective optical system; and
a control device that (a) controls the micro image capturing device to captures the micro image of the specimen, (b) controls the focus adjustment device to carry out focus adjustment operation after the captured micro image is displayed on the micro image display device, (c) controls the micro image capturing device to capture the micro image again, and (d) updates the micro image displayed on the micro image display device.

7. A microscope system according to claim 6, further comprising:
a stage on which a slide glass that holds the specimen is mounted, wherein:
the observation position control device moves the stage in a plane substantially perpendicular to the optical axis of the objective optical system so as to move the observation position of the specimen specified by the specifying device to the optical axis of the objective optical system, and
the control device engages the focus adjustment device in operation when it is detected that the observation position of the specimen has reached the optical axis of the objective optical system by the observation position control device.

8. A microscope system, comprising:
an objective optical system used to observe a specimen;
a focus adjustment device that adjusts a focus position of the objective optical system;
a start instruction device that instructs to start operation of the focus adjustment device;
a specifying device that specifies an observation position of the specimen;
an observation position control device that matches the observation position of the specimen specified by the specifying device with an optical axis of the objective optical system; and
a control device that engages the focus adjustment device in operation after the observation position control device matches the observation position with the optical axis in accordance with a signal from the specifying device in a case no instruction to start the operation is issued from the start instruction device.

9. A microscope system according to claim 8, further comprising:
an image-capturing device that captures an image of the specimen via the objective optical system; and
an image display device that displays the image of the specimen captured by the image-capturing device, wherein:
when the observation position control device shifts the observation position in the specimen in accordance with the signal from the specifying device after the image captured by the image-capturing device is displayed on the image display device, the control device controls the focus adjustment device to start executing focus adjustment operation, controls the image-capturing device to capture the image again and updates the image displayed on the image display device.

10. A microscope system according to claim 1, further comprising:
an image-capturing device that captures an image of the specimen, wherein:
the focus adjustment device detects the focus position of the objective optical system based on the image of the specimen captured by the image-capturing device.

11. A microscope system according to claim 6, wherein:
the focus adjustment device detects the focus position of the objective optical system based on the micro image of the specimen captured by the micro image capturing device.

12. A microscope system according to claim 9, wherein:
the focus adjustment device detects the focus position of the objective optical system based on the image of the specimen captured by the image-capturing device.
